(19) United States
(12) Patent Application Publication
(10) Pub. No.: US 2013/0186192 A1
(43) Pub. Date: Jul. 25, 2013

(54) WIND TUNNEL TEST MODEL AND WIND TUNNEL TEST METHOD

(71) Applicants: Motohide Uehara, Tokyo (JP); Satoshi Yonemoto, Tokyo (JP); Hidehiko Kato, Tokyo (JP); Takayuki Nomura, Tokyo (JP); Masashi Nagahata, Tokyo (JP)

(72) Inventors: Motohide Uehara, Tokyo (JP); Satoshi Yonemoto, Tokyo (JP); Hidehiko Kato, Tokyo (JP); Takayuki Nomura, Tokyo (JP); Masashi Nagahata, Tokyo (JP)

(21) Appl. No.: 13/876,018

(22) PCT Filed: Sep. 30, 2011
(86) PCT No.: PCT/JP2011/072518

§ 371 Date: Mar. 26, 2013

(30) Foreign Application Priority Data
Oct. 4, 2010 (JP) 2010-225174

(51) Int. Cl. G01M 9/04; G01M 9/08

(52) U.S. Cl. CPC G01M 9/04; G01M 9/08
USPC 73/118.03

(57) ABSTRACT

A wind tunnel test model (1) includes a half model portion (3) that simulates a fuselage portion of an airframe with a single wing and a supporting apparatus (5) that supports the half model portion rotatably about a central axis. The supporting apparatus has a horizontal cross-sectional shape that is approximately the same as or similar to that of the fuselage portion (7) and extends rearward of the fuselage portion, includes, toward its rear end, a fixing portion (11) that fixes the half model portion to a wind tunnel test apparatus side, and includes, within a housing, a torsional rigidity imparting unit.

### TECHNICAL FIELD

The present invention relates to a wind tunnel test model and a method of wind tunnel testing.

### BACKGROUND ART

When an aircraft flies at the subsonic or transonic range, there is a possibility that an antisymmetric mode flutter may occur. An antisymmetric mode flutter is a flutter phenomenon in which left and right wings of an aircraft vibrate in opposite phases (i.e., antisymmetric mode). Thus, before a flight, or in order to verify the accuracy of an aeroelastic analysis, a wind tunnel test that uses a model of an aircraft is performed.

Wind tunnel test models that are used in such wind tunnel tests for an antisymmetric mode flutter include full models that simulate a fuselage portion of an airframe with both wings and half models that simulate a fuselage portion of an airframe with a single wing.

In cases of the full models, which have both wings, antisymmetric aerodynamic forces applied to the left and right wings can be simulated (see FIG. 3(a) of Patent Literature 1), and this is advantageous in that an antisymmetric mode flutter can be reproduced.

However, in cases of the full models, the scale of the respective wings has to be smaller than that of the half models if those models are mounted in wind tunnel test apparatuses of the same size. A reduction of the scale will decrease the model manufacturing accuracy (vibration characteristics simulating accuracy and matching accuracy between left and right wings). Accordingly, a relatively large wind tunnel test apparatus is necessary in order to use a full model. However, in Japan there is only a limited number of large wind tunnel test apparatuses in which a test for an antisymmetric mode flutter can be performed, and these are often subject to conditions of use such as; a model should not be destroyed, only a model of an aircraft type that is suited to the intended purpose of the equipment is permitted, and so on. Furthermore, there is another problem in that usage fees for wind tunnels are expensive.

Thus, attention is paid to the half models that can be mounted even in relatively small wind tunnel test apparatuses and that enable the scale of a single wing to be increased as compared to the full models and promise an improvement of accuracy.

An example of a method for mounting a half model in a wind tunnel test apparatus is, as shown in FIG. 4(b) of Patent Literature 1, a method in which a half model is attached to a wind tunnel wall using a supporting apparatus that simulates degrees of freedom of roll of an airframe. However, even though this method can simulate antisymmetry of the vibration characteristics, aerodynamic forces can only be symmetric as shown in FIG. 3(c) of Patent Literature 1. Accordingly, the wind tunnel test is not effective in cases of mild flutter that occurs at a lower speed range than the speed at which typical bending-torsion flutter occurs, LCO (Limit Cycle Oscillation), or the like, where slight differences in aerodynamic force have a great influence on the flutter characteristics.

To solve such problems, Patent Literature 1 proposes a method in which a pivot point of the half model is positioned away from the wind tunnel wall. This can eliminate the influence of the wind tunnel wall and, as shown in FIG. 3(b) of Patent Literature 1, enables reproduction of antisymmetric aerodynamic forces with the aerodynamic force at the pivot point being eliminated.

### CITATION LIST

### Patent Literature

{PTL 1}
Japanese Unexamined Patent Application, Publication No. Hei3-242524

### SUMMARY OF INVENTION

### Technical Problem

However, in Patent Literature 1, as shown in FIG. 1(b) of this patent literature, the half model is supported by a support strut from below. With this structure, the support strut constitutes a resistance and may disturb the wind conditions around the half model. Furthermore, separate structural work such as the formation of a hole in a lower portion of the wind tunnel wall in order to mount the support strut is necessary, and much time and cost are required for the preparation of a wind tunnel test.

The present invention has been made in view of circumstances as described above, and it is an object thereof to provide a wind tunnel test model that can be mounted without requiring much time and cost, can be supported without disturbing the wind conditions around the half model, and can thus realize a wind tunnel test for an antisymmetric mode flutter with high accuracy, and a method of wind tunnel testing.

### Solution to Problem

In order to solve the above-described problems, a wind tunnel test model and a method of wind tunnel testing of the present invention employ the following solutions.

That is, a wind tunnel test model according to a first aspect of the present invention is a wind tunnel test model including a half model portion that simulates a fuselage portion of an airframe with a single wing, and a supporting apparatus that, in a position spaced away from a wind tunnel wall, supports the half model portion rotatably about a central axis, wherein the supporting apparatus has a horizontal cross-sectional shape that is approximately the same as or similar to that of the fuselage portion and extends rearward of the fuselage portion, includes, toward its rear end side, a fixing portion that fixes the half model portion to a wind tunnel test apparatus side, and includes, within a housing, a torsional rigidity imparting unit that imparts a predetermined torsional rigidity about the central axis to the half model portion.

Spacing the supporting apparatus, which supports the half model portion rotatably about the central axis, away from the wind tunnel wall enables not only the vibration characteristics but also the aerodynamic forces to be simulated, so that an antisymmetric mode flutter can be accurately reproduced.

Moreover, the supporting apparatus has a horizontal cross-sectional shape that is approximately the same as or similar to that of the fuselage portion and extends rearward of the fuselage portion, and therefore does not interfere with the wind conditions with respect to the half model portion that is located on a front side (upstream side of fluid flow). Furthermore, the fixing portion, which fixes the half model portion to the wind tunnel test apparatus side, is provided toward the rear end side of the supporting apparatus, and therefore does not interfere with the wind conditions with respect to the half model portion.

Moreover, the supporting apparatus includes the torsional rigidity imparting unit, which imparts a predetermined torsional rigidity about the central axis to the half model portion, and therefore can provide a counter torque against a moment in a rolling direction of the half model portion that is generated by aerodynamic forces. Furthermore, since the torsional rigidity imparting unit is housed in the housing of the supporting apparatus, the torsional rigidity imparting unit does not disturb the wind conditions.

A typical example of the torsional rigidity imparting unit is a torque shaft such as a round bar, and a coil spring and the like can also be used.

With regard to the torsional rigidity of the torsional rigidity imparting unit, it is preferable to select a level of torsional rigidity that generates a counter torque when a steady lift of the half model portion is produced. Adjustment of the torsional rigidity is performed by, for example, changing the polar modulus of section by changing the horizontal cross-sectional shape of the torque shaft.

Furthermore, in the wind tunnel test model according to the first aspect, a configuration in which the fixing portion fixes the supporting apparatus to a sting mount provided in a wind tunnel test apparatus may also be adopted.

The use of the sting mount provided in the wind tunnel test apparatus makes it possible to use the equipment for an existing test apparatus and to perform a wind tunnel test without additional structural work and additional costs.

Moreover, when the axis of the sting mount and the central axis of the half model portion are fixed so as to be approximately parallel to each other and offset from each other, the torsional rigidity imparting unit can be inserted and removed from the rear of the supporting apparatus after the wind tunnel test model has been fixed to the sting mount, and operations of the wind tunnel test are facilitated.

Furthermore, in the wind tunnel test model according to the first aspect, a configuration may also be adopted in which the torsional rigidity of the torsional rigidity imparting unit is set such that the torsional rigidity imparting unit has a primary natural frequency that is ⅓ or less and preferably ⅕ or less of the primary natural frequency of the half model portion.

The torsional rigidity of the torsional rigidity imparting unit is sufficient as long as the torsional rigidity is at such a level that generates a counter torque when a steady lift of the half model portion is produced, and a torsional rigidity that is greater than this level is unfavorable in view of understanding of the vibration characteristics (in particular, an antisymmetric mode flutter) of the half model portion. Accordingly, it is preferable that the torsional rigidity is set such that the torsional rigidity imparting unit has ⅓ or less of a primary natural frequency, preferably ⅕ or less of the primary natural frequency, of the half model portion.

Furthermore, in the wind tunnel test model according to the first aspect, a configuration may also be adopted in which the torsional rigidity imparting unit is a bar-shaped torque shaft, the torque shaft is fixed at its front end to the fuselage portion side and a rear end side of the torque shaft is fixed in a predetermined fixing position with respect to the housing of the supporting apparatus, and the fixing position can be changed in a longitudinal direction of the torque shaft.

Allowing the fixing position of the torque shaft to be changed in the longitudinal direction thereof makes it possible to change the distance between the front end that is fixed to the fuselage portion side and the fixing position. Thus, the torsional rigidity can be adjusted to an appropriate value.

Moreover, a method of wind tunnel testing according to a second aspect of the present invention includes attaching the above-described wind tunnel test model to a wind tunnel test apparatus and performing a wind tunnel test for antisymmetric mode flutter.

Since the above-described wind tunnel test model is used to perform a wind tunnel test, an antisymmetric mode flutter can be accurately realized.

### Advantageous Effects of Invention

Since the half model portion is supported by the supporting apparatus that is provided to the rear of the half model portion, it is possible to support the half model portion without disturbing the wind conditions therearound.

Moreover, since the wind tunnel test model is mounted at a distance from the wind tunnel wall and the half model portion is supported using the torque shaft that provides a proper counter torque against a steady lift, a wind tunnel test for an antisymmetric mode flutter can be realized with high accuracy.

### BRIEF DESCRIPTION OF DRAWINGS

FIG. 1 is a perspective view showing a state in which a wind tunnel test model according to an embodiment of the present invention is fixed to a sting mount.

FIG. 2 is a partially cross-sectional plan view of the wind tunnel test model in FIG. 1.

FIG. 3A is a diagram showing moments M on a full model that are produced when a steady lift L acts on this model.

FIG. 3B is a diagram showing a moment M on a half model that is produced when a steady lift L acts on this model.

FIG. 4A illustrates an aerodynamic force distribution in the case where a half model is used and the half model is mounted on a wind tunnel wall in a rotatable (free-to-roll) manner.

FIG. 4B illustrates an aerodynamic force distribution in the case where a half model is used and the half model is mounted in a position away from a wind tunnel wall in a rotatable (free-to-roll) manner.

### DESCRIPTION OF EMBODIMENTS

An embodiment of the present invention will be described below with reference to the drawings.

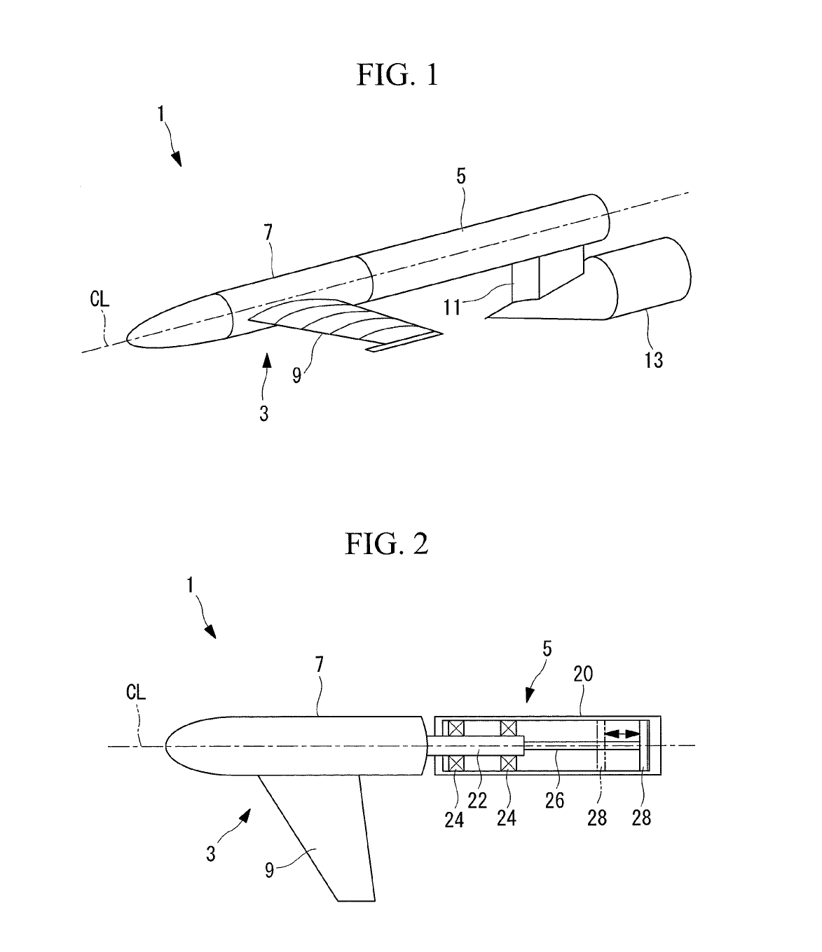

FIG. 1 shows a wind tunnel test model 1 that is used in a wind tunnel test for an antisymmetric mode flutter.

The model 1 has a half model portion 3 that simulates a fuselage portion of an airframe with a single wing and a supporting apparatus 5 that supports the half model portion 3 in such a manner that it is rotatable (free-to-roll) about a central axis CL.

The half model portion 3 includes a fuselage portion 7 that simulates a front portion of a fuselage of an airframe and a wing 9 that simulates a single wing of an airframe.

The fuselage portion 7 has a tapered cylindrical shape. The shape of this fuselage portion 7 is not a half shape obtained by halving a fuselage along a vertical plane containing its central axis as shown in Patent Literature 1. The reason for this is that maintaining a cylindrical shape as shown in FIG. 1 will more greatly contribute to an improvement of measurement accuracy, without disturbing the flow of air. Accordingly, in the present embodiment, the weight of the fuselage portion 7 is adjusted so that the moment of inertia thereof is ½ of that in the case of a full model.

The supporting apparatus 5 is connected to a rear end (downstream side of air flow) of the fuselage portion 7, and the horizontal cross-sectional shape that defines the outer shape of this apparatus is approximately the same as the horizontal cross-sectional shape of the rear end of the fuselage portion 7.

The supporting apparatus 5 includes, toward its rear end side, a fixing portion 11 for fixing the half model portion 3 to a wind tunnel test apparatus side. The fixing portion 11 is attached so as to extend upright from a leading end of a sting mount (sting pod) 13 that is already provided in a wind tunnel test apparatus. The sting mount 13 is originally intended for a model to be rigidly fixed to its leading end via a sting. In the present embodiment, the sting mount 13 is used in order to rotatably fix the half model portion 3.

Mounting is performed so that an axis of the sting mount 13 and the central axis of the half model portion 3 are approximately parallel to each other. Moreover, the axis of the sting mount 13 and the central axis of the half model portion 3 are offset from each other by positioning the fixing portion 11 so as to extend upright from the sting mount 13. This offset enables a torque shaft 26 (see FIG. 2), which will be described later, to be inserted and removed from the rear of the supporting apparatus 5 after the wind tunnel test model 1 has been fixed to the sting mount 13, and facilitates operations of a wind tunnel test.

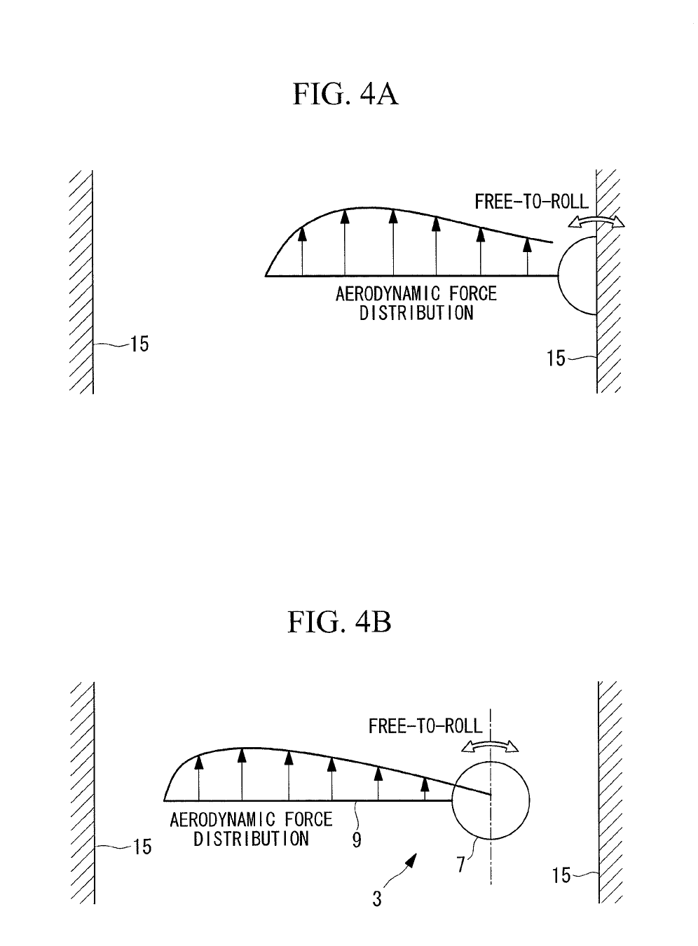

Attaching the half model portion 3 to the sting mount 13 enables the half model 3 to be mounted in the wind tunnel test apparatus in a state in which it is spaced away from the wind tunnel wall 15 as shown in FIG. 4B. Thus, the aerodynamic force at the center of rotation of the half model portion 3 can be eliminated. It should be noted that FIG. 4A shows, as a reference example, a case where a half model is mounted on the wind tunnel wall 15 in a rotatable (free-to-roll) manner. If a half model is mounted on the wind tunnel wall 15 in this manner, the aerodynamic force at the center of rotation of the half model cannot be eliminated, and an asymmetric aerodynamic force distribution cannot be obtained.

FIG. 2 shows an internal structure of the supporting apparatus 5 that supports the half model portion 3. A rotation shaft 22 that is fixed to the rear end of the fuselage portion 7 is inserted in a housing 20 of the supporting apparatus 5. The rotation shaft 22 extends rearward (rightward in this figure) from the rear end of the fuselage portion 7 along the central axis CL.

A pair of radial bearings 24 that rotatably support the rotation shaft 22 and the torque shaft (torsional rigidity imparting unit) 26 that is fixed to the rotation shaft 22 are provided in the housing 20 of the supporting apparatus 5.

Moreover, although not shown, it is configured that wiring that conducts output signals from sensors provided in respective locations of the half model portion 3 passes within the housing 20 of the supporting apparatus 5. The wiring is drawn out from the supporting apparatus 5 and led to an external calculation processing unit, which is not shown. It is assumed that the wiring passes through a space between the housing 20 and the torque shaft 26, but it is also possible that a hollow torque shaft is used and the wiring passes through a space within the torque shaft.

The torque shaft 26 is a bar-like member such as a round bar, and is fixed, at its leading end, to a rear end of the rotation shaft 22 and, on its rear end side, to the torque shaft fixing member 28. The torque shaft fixing member 28 is used to fix the torque shaft 26 to the housing 20 side and is configured so that it can be moved in the direction of the central axis CL to fix the torque shaft 26 in any desired position. In this manner, with the torque shaft fixing member 28, the fixing position of the rear end side of the torque shaft 26 can be arbitrarily set, so that the torsional rigidity of the torque shaft 26 can be arbitrarily set by changing a distance between the leading end of the torque shaft 26 and the fixing position of the rear end side of the torque shaft.

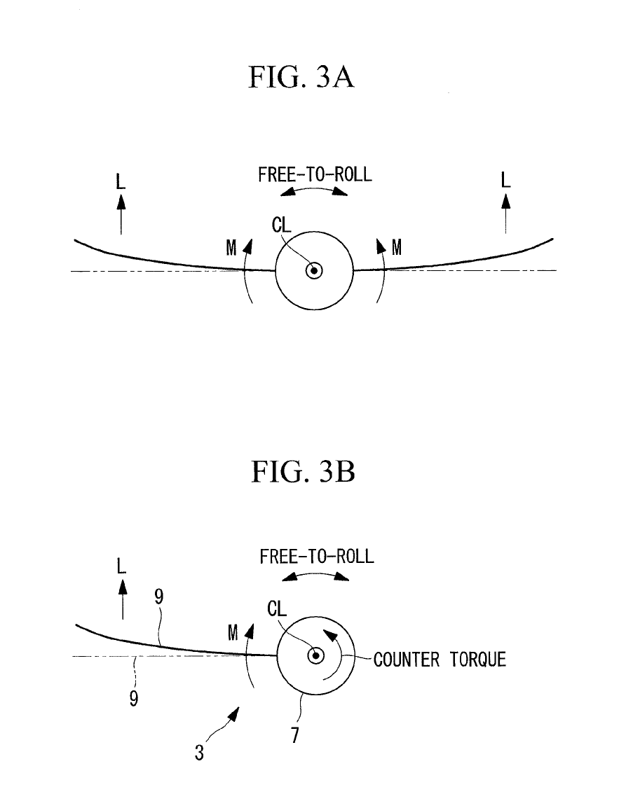

FIG. 3 illustrates the concept of setting of the torsional rigidity of the torque shaft 26. As shown in FIG. 3A, in the case of a full model, even if a steady lift L is generated and moments M about the central axis CL are produced, the moments M can be cancelled out by the left and right wings. However, in the case of a half model as in the present embodiment, since a lift L on only a single wing is produced and only a moment M in one direction about the central axis CL is produced, it is necessary to cause a counter torque to act on the half model in order to cancel this moment out. It is the torque shaft 26 shown in FIG. 2 that produces this counter torque. When the torque shaft 26 has a great torsional rigidity, it can produce a counter torque against the steady lift L, but if the torsional rigidity is so great that even vibration caused by the occurrence of an antisymmetric mode flutter is cancelled out, the original purpose of testing cannot be achieved. Accordingly, it is preferable that the torsional rigidity of the torque shaft 26 is as great as is necessary and sufficient enough to provide a counter torque against the steady lift L. The inventors of the present invention have studied the torsional rigidity of the torque shaft 26 from such a point of view and found that it is effective to set the torsional rigidity such that the torque shaft 26 has ⅓ or less of a primary natural frequency, preferably ⅕ or less of the primary natural frequency, of the half model portion 3.

Appropriately setting the torsional rigidity of the torque shaft 26 in this manner will eliminate interference with the vibration characteristics of the half model portion 3 in the case where an antisymmetric mode flutter occurs.

As described above, according to the wind tunnel test model and the method of wind tunnel testing of the present embodiment, the following effects are obtained.

Spacing the supporting apparatus 5, which supports the half model portion 3 rotatably about the central axis CL, away from the wind tunnel wall (see FIG. 4B) enables not only the vibration characteristics but also the aerodynamic forces to be simulated, so that an antisymmetric mode flutter can be accurately reproduced.

Moreover, the supporting apparatus 5 has approximately the same horizontal cross-sectional shape as the rear end of the fuselage portion 7 and extends rearward thereof, and therefore, does not interfere with the wind conditions with respect to the half model portion 3, which is located on the front side (upstream side of fluid flow). Furthermore, the fixing portion 11 is provided toward the rear end of the supporting apparatus 5, and therefore does not interfere with the wind conditions with respect to the half model portion 3.

Moreover, the supporting apparatus 5 includes the torque shaft 26, which imparts a predetermined torsional rigidity about the central axis CL to the half model portion 3, and therefore can provide a counter torque against the moment M in the rolling direction of the half model portion 3 that is generated by aerodynamic forces. Furthermore, since the torque shaft 26 is housed in the housing 20 of the supporting apparatus 5, the torque shaft 26 does not disturb the wind conditions.

The use of the sting mount 13 provided in the wind tunnel test apparatus makes it possible to use the equipment for an existing test apparatus and to perform a wind tunnel test without additional structural work and additional costs.

It should be noted that although the horizontal cross-sectional shape of the supporting apparatus 5 was approximately the same as the horizontal cross-sectional shape of the rear end of the fuselage portion 7 in the present embodiment, the present invention is not limited to this, and it is also possible that the horizontal cross-sectional shape of the supporting apparatus and the horizontal cross-sectional shape of the rear end of the fuselage portion are similar.

Moreover, although the torque shaft 26 was used as the torsional rigidity imparting unit in the present embodiment, the present invention is not limited to this as long as a desired torsional rigidity can be provided, and a coil spring or the like may also be used.

Moreover, although the torsional rigidity of the torque shaft 26 was changed by changing the position of the torque shaft fixing member 28 in the present embodiment, in addition to this, the torsional rigidity of the torque shaft 26 may also be adjusted by, for example, changing the polar modulus of section by changing the horizontal cross-sectional shape of the torque shaft.

### REFERENCE SIGNS LIST

1 Wind tunnel test model
3 Half model portion
5 Supporting apparatus
11 Fixing portion
13 Sting mount
20 Housing
26 Torque shaft (torsional rigidity imparting unit)
CL Central axis

1. A wind tunnel test model comprising:
a half model portion that simulates a fuselage portion of an airframe with a single wing; and
a supporting apparatus that, in a position spaced away from a wind tunnel wall, supports the half model portion rotatably about a central axis,
wherein the supporting apparatus has a horizontal cross-sectional shape that is approximately the same as or similar to that of the fuselage portion and extends rearward of the fuselage portion, includes, toward its rear end side, a fixing portion that fixes the half model portion to a wind tunnel test apparatus side, and includes, within a housing, a torsional rigidity imparting unit that imparts a predetermined torsional rigidity about the central axis to the half model portion.

2. The wind tunnel test model according to claim 1, wherein the fixing portion fixes the supporting apparatus to a sting mount provided in a wind tunnel test apparatus.

3. The wind tunnel test model according to claim 1, wherein a torsional rigidity of the torsional rigidity imparting unit is set such that the torsional rigidity imparting unit has ⅓ or less of a primary natural frequency, preferably ⅕ or less of a primary natural frequency, of the half model portion.

4. The wind tunnel test model according to claim 1,
wherein the torsional rigidity imparting unit is a bar-shaped torque shaft,
the torque shaft is fixed at its front end to the fuselage portion side, and a rear end side of the torque shaft is fixed in a predetermined fixing position with respect to the housing of the supporting apparatus, and
the fixing position can be changed in a longitudinal direction of the torque shaft.

5. A method of wind tunnel testing, comprising:
attaching the wind tunnel test model according to claim 1 to a wind tunnel test apparatus, and
performing a wind tunnel test for antisymmetric mode flutter.
